(19) United States
(12) Patent Application Publication
(10) Pub. No.: US 2026/0105649 A1
(43) Pub. Date: Apr. 16, 2026

(54) SYSTEM AND METHOD FOR AUTOMATED GENERATION OF INTERACTIVE STORIES

(71) Applicant: Centerstage Technologies LLC, Westlake Village, CA (US)

(72) Inventors: Zank Bennett, Alta Loma, CA (US); Andrii Volkov, Alcochete (PT); Tarlan Ahadli, Budapest (HU); Andriy Orlov, Düsseldorf (DE)

(21) Appl. No.: 19/332,000

(22) Filed: Sep. 17, 2025

Related U.S. Application Data
(60) Provisional application No. 63/695,649, filed on Sep. 17, 2024.

(51) Int. Cl. G06T 11/00; G06F 40/166; G06T 5/60; G06T 5/77; G06T 13/40; G06T 13/80

(52) U.S. Cl. CPC G06T 11/00; G06F 40/166; G06T 5/60; G06T 5/77; G06T 13/40; G06T 13/80; G06T 2207/20081; G06T 2207/30196

(57) ABSTRACT

A computer-implemented system for automatically generating personalized interactive stories includes a data input module, a model generation module that contains a first generative AI model configured to generate initial images based on the received reference images and text prompts, an inpainting module designed to transfer of a character's appearance to a control image, an animation generation module having a framework for creating customized visual animation sequences based on text prompts and generated images, a narrative generation module including a dynamic prompting architecture for generating narrative text, and an output module for combining the generated images, video sequences, and narrative text into a cohesive, interactive story and present the generated content to a user.

### CROSS-REFERENCE TO RELATED APPLICATIONS

This patent application claims priority to provisional patent application 63/695,649 filed Sep. 17, 2024. The subject matter of provisional patent application 63/695,649 is hereby incorporated by reference in its entirety.

### STATEMENT REGARDING FEDERALLY SPONSORED RESEARCH OR DEVELOPMENT

### Not Applicable.

### INCORPORATION BY REFERENCE OF MATERIAL SUBMITTED ON A COMPACT DISC

Not Applicable.

### TECHNICAL FIELD

The claimed subject matter relates generally to artificial intelligence systems, and more specifically, to systems and methods for generating personalized interactive stories using text prompts, reference images, and generative models for image, video, and narrative synthesis.

### BACKGROUND

Advancements in artificial intelligence (AI) and machine learning have significantly impacted various creative industries, including digital content creation, storytelling, and image generation. Technologies such as large language models (LLMs) and diffusion models have enabled the automated generation of text, images, and even video content, providing new tools for artists, writers, and content creators. These AI-driven systems can produce highly detailed images, coherent narratives, and even short animations based on user-provided prompts or predefined datasets. Current AI models can be trained to generate images or narratives based on specific themes or characters, often utilizing reference images or text descriptions to guide the creation process. These models, however, face several limitations.

Current systems often struggle with maintaining consistency across multiple generated images or scenes, especially when depicting specific characters in various settings. For example, while a model may generate an accurate image of a character in one scene, subsequent scenes may show variations in appearance, style, or other visual attributes. This lack of consistency can be jarring, particularly in storytelling contexts where character continuity is essential. Also, many AI models require substantial amounts of training data and computational resources to fine-tune for specific tasks, such as customizing a character's appearance across different images. Traditional fine-tuning processes can be both time-consuming and expensive, limiting the accessibility of these technologies for smaller creators or individual users. The need for large datasets and extended training periods also reduces the flexibility of the models, making it challenging to adapt them to new characters or styles quickly.

Further, although some AI models allow for customization, the level of control over specific aspects of the generated content is often limited. Users may be able to define general parameters or provide reference images, but fine-tuning details such as character traits, clothing, or specific scene elements typically requires significant manual intervention. This limitation hampers the ability to produce truly personalized content that aligns with the user's vision or the specific requirements of a project. Additionally, the scalability of current AI-driven content generation systems is often limited. As cultural trends and storytelling techniques evolve, models may require frequent retraining or adjustment to remain relevant, which can be resource-intensive and impractical on a large scale.

Therefore, what is needed is a system and method for improving the problems with the prior art, and more particularly for a more expedient and efficient method and system for automatically generating interactive stories.

### BRIEF SUMMARY

A computer-implemented process for automated generation of interactive stories that addresses the problems with the prior art, is provided. This Summary is provided to introduce a selection of disclosed concepts in a simplified form that are further described below in the Detailed Description, including the drawings. This Summary is not intended to identify key features or essential features of the claimed subject matter. Nor is this Summary intended to be used to limit the claimed subject matter's scope

In one embodiment, a computer-implemented system for automatically generating personalized interactive stories comprises a data input module configured for receiving reference images, text prompts, and scene details that define the appearance and context of characters and scenes, a model generation module comprising: i) a first generative AI model configured to generate initial images based on the received reference images and text prompts, ii) a fine-tuning module configured to fine-tune the first generative AI model using a set of character-specific images to generate customized per-character models and multi-character models, and iii) a second generative AI model module configured to utilize output from the per-character models to train the multi-character models, an inpainting module configured for transfer of a character's appearance to a control image, the inpainting module comprising: i) a character of interest identification sub-module configured to locate a character of interest within the control image, ii) an integration sub-module configured to position the character of interest similarly to the control image, and iii) an appearance transfer module configured to transfer the appearance of the character of interest to the control image by providing a smooth blending that respects the appearance of the character of interest and the style of the control image, an animation generation module comprising: i) a framework configured to create customized visual animation sequences based on the text prompts and images that were generated, and ii) a service integration module configured to utilize third-party services for direct animation with limited control, a narrative generation module comprising: i) a dynamic prompting architecture configured to generate narrative text by leveraging predefined screenwriting techniques and modular prompt structures, ensuring narrative cohesion and character trait preservation, and ii) a cultural sensitivity matrix and age-appropriate content filter configured to tailor the narrative content to specific developmental stages and cultural norms, and an output module configured to combine the generated images, video sequences, and narrative text into a cohesive, interactive story and present the content that was generated to a user.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for executing a computer-implemented process for the automated generation of interactive stories over a communications network, in accordance with one embodiment.

FIG. 2 is a block diagram showing the data flow of the computer-implemented process for the automated generation of interactive stories over a communications network, according to one embodiment.

FIG. 3 is a flow chart depicting the general control flow of the computer-implemented process for the automated generation of interactive stories over a communications network, according to one embodiment.

FIG. 4 is a block diagram depicting a system including an example computing device and other computing devices.

FIG. 5 is a block diagram depicting the modules of the system for executing a computer-implemented process for the automated generation of interactive stories, according to one embodiment.

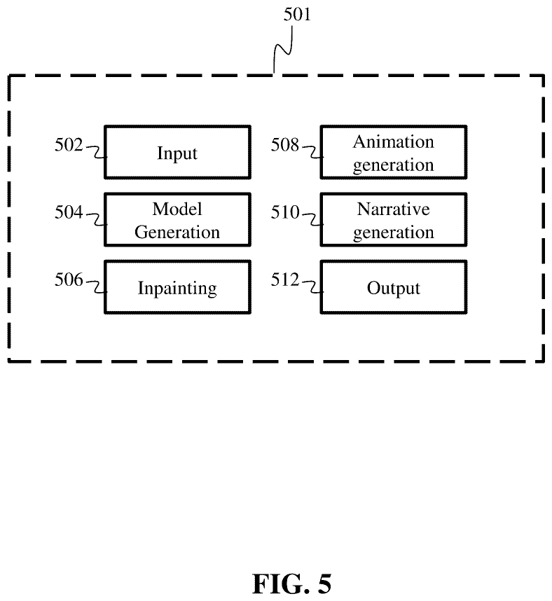

FIG. 6 is a block diagram depicting the sub-modules of the system for executing a computer-implemented process for the automated generation of interactive stories, according to one embodiment.

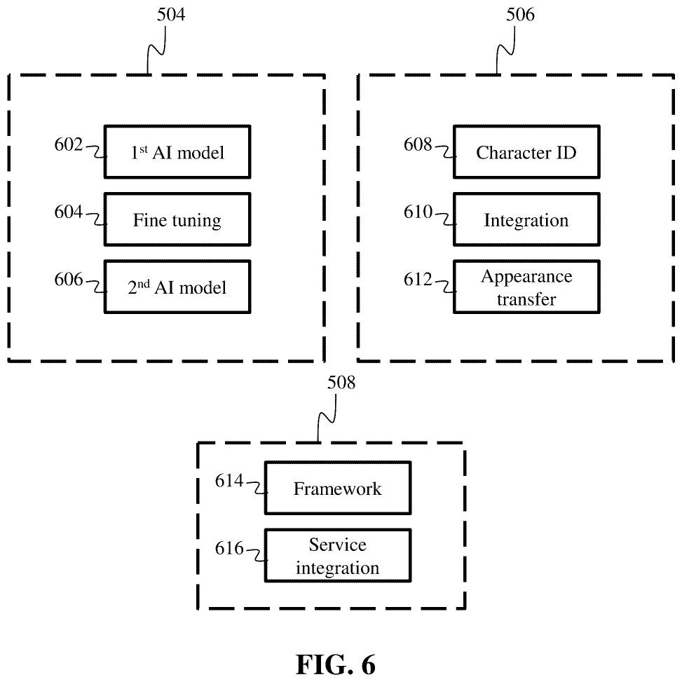

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The disclosed embodiments improve upon the problems with the prior art by addressing the key challenges of consistency, customization, and resource efficiency in the generation of personalized interactive stories. Unlike existing systems that often struggle with maintaining visual and narrative continuity, the disclosed embodiments employ advanced AI techniques such as fine-tuning to ensure that characters maintain consistent appearances across different scenes. By fine-tuning the AI model with a minimal set of character-specific images, the system can generate highly personalized and consistent visuals without requiring extensive training data or computational resources. This not only enhances the visual coherence of the generated content but also reduces the time and expense typically associated with model customization. Furthermore, the disclosed embodiments offer a higher level of control and adaptability in content creation compared to prior systems. The inclusion of a dynamic prompting architecture allows for the generation of narrative text that adheres to professional storytelling principles while preserving character traits and ensuring cultural sensitivity. The modular approach to prompt generation and the integration of an age-appropriate content filter provide a tailored storytelling experience that is both inclusive and relevant to a global audience. Additionally, the disclosed embodiments'capability to combine AI-generated images, videos, and narratives into cohesive interactive stories addresses the integration challenges found in previous systems. This comprehensive solution not only streamlines the content creation process but also enables scalable and adaptable storytelling that can evolve with cultural trends and user preferences.

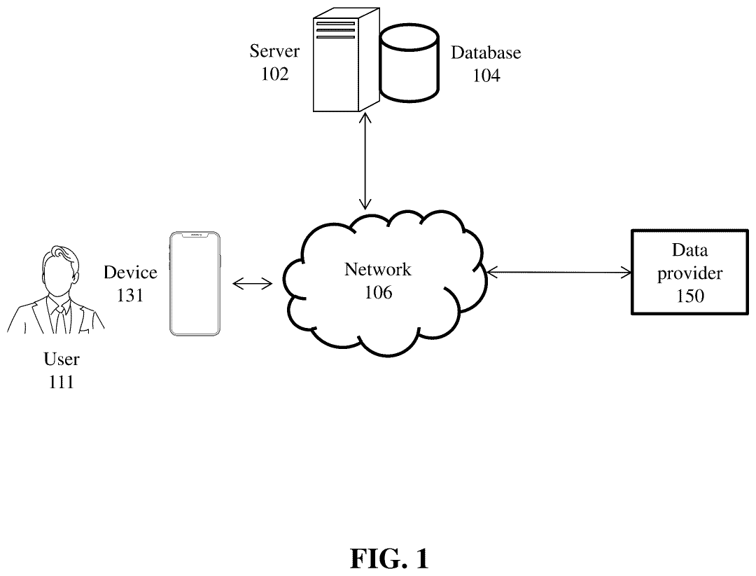

Referring now to the drawing figures in which like reference designators refer to like elements, there is shown in FIG. 1 an illustration of a block diagram showing the network architecture of a system 100 and method for the automated generation of interactive stories in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating the process for the automated generation of interactive stories.

FIG. 1 includes computing devices 131 and 102, which may be smart phones, mobile phones, tablet computers, handheld computers, laptops, or the like. In another embodiment, computing devices 131 and 102 may be workstations, desktop computers, servers, laptops, all-in-one computers, or the like. In another embodiment, computing devices 131, 102 may be AR or VR systems that may include display screens, headsets, heads up displays, helmet mounted display screens, or the like. Computing device 131 corresponds to a user 111 of the claimed embodiments. Devices 131, 102 may be communicatively coupled with network 106 in a wired or wireless fashion.

FIG. 1 further shows that server 102 includes a database or repository 104, which may be a relational database comprising a Structured Query Language (SQL) database stored in a SQL server. Device 131 may also include its own database. The repository 104 serves data from a database, which is a repository for data used by server 102 and device 131 during the course of operation of the disclosed embodiments. Database 104 may be distributed over one or more nodes or locations that are connected via network 106.

The database 104 may include a user record for each user 111. A user record may include: contact/identifying information for the user (name, address, telephone number(s), email address, etc.), information pertaining to 2D images of the user, information pertaining to 3D models of the user, etc. A user record may also include a unique identifier for each user. A user record may further include demographic data for each user, such as age, sex, income data, race, color, marital status, etc. The database 104 may include 2D reference images utilized by each user, as well as 3D objects and 3D models. The database 104 may also include a configuration file for each user.

FIG. 1 shows an embodiment wherein networked computing device 131 interacts with server 102 and repository 104 over the network 106. It should be noted that although FIG. 1 shows only the networked computers 131 and 102, the system of the disclosed embodiments supports any number of networked computing devices connected via network 106. Further, server 102, and unit 131 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as device 131. Further, server 102 and its functionality, according to a preferred embodiment, can be realized in a centralized fashion in one computer system or in a distributed fashion wherein different elements are spread across several interconnected computer systems.

FIG. 1 also shows a data provider 150 connected to network 106. The data provider 150 represents an entity that provides data that is used by the claimed embodiments, such as 2D reference images or 3D models. The data provider 150 may also represent the information technology infrastructure, including servers and computers, which are used by the data provider 150.

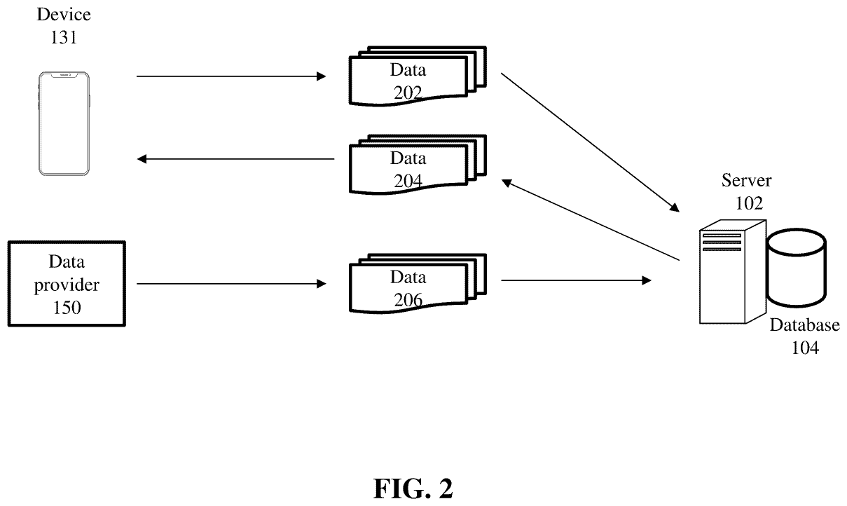

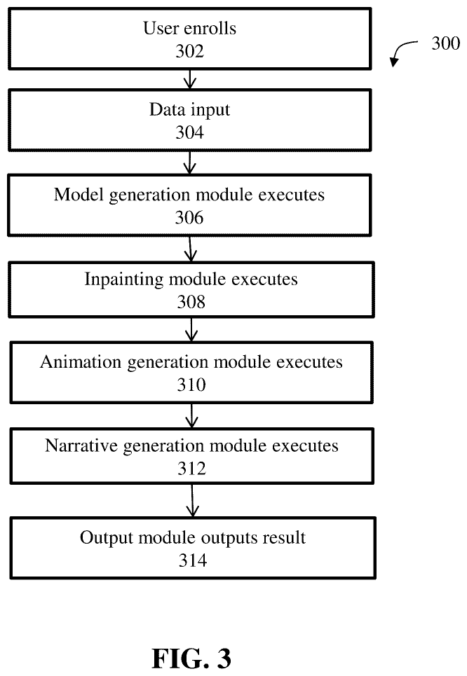

The process of the automated generation of interactive stories over a communications network will now be described with reference to FIGS. 2-3 below. FIGS. 2-3 depict the data flow and control flow of the process for the automated generation of interactive stories over a communications network 106, according to one embodiment. The process of the disclosed embodiments is referred to as a program, computer program, executable or a set of computer-readable instructions (all referred to by the item number 501) configured to execute on one or more processors. Said program 501 may comprise a plurality of modules described below.

The process of the disclosed embodiments begins with optional step 302 (see flowchart 300), wherein the user 111 may enroll or register with server 102. In the course of enrolling or registering, or afterwards in step 304, the user may enter data 202 into his device by manually entering or uploading data (such as 2D reference images and text prompts) into a mobile application via keypad, touchpad, or via voice. In the course of enrolling or registering, the user may enter any data that may be stored in a user record, as defined above. Also in the course of enrolling or registering, the server 102 may generate a user record for each registering user and store the user record in an attached database, such as database 104. In the course of enrolling or registering, the user may also identify or upload 2D/3D reference images, text prompts, and scene details 202 that define the appearance and context of characters and scenes, which are used throughout the process described below. Alternatively, the 2D/3D reference images, text prompts, and scene details 206 may be uploaded, or read, from data provider 150. Said data input in step 302 is input via a data input module 502 that is part of the program 501.

In step 306, the model generation module 504 executes. The model generation module comprises: i) a first generative AI model 602 configured to generate initial images based on the received data 202/206, ii) a fine-tuning module 604 configured to fine-tune the first generative AI model using a small set of character-specific images to generate customized per-character models and/or multi-character models, and iii) a second generative AI module 606 configured to utilize output from the per-character models to train the multi-character models, in order to produce consistent visual styles and character appearances across different scenes. The model generation module is responsible for creating the visual content that will be used throughout the interactive story generation process. In another embodiment, the tasks performed by the first generative AI model, the fine-tuning model and the 2nd generative AI model of the model generation module above can be performed at once by a single model that can perform multiple tasks at once, including generating initial images with consistent characters in the provided reference style.

The first subcomponent of the model generation module is the first generative AI model 602 designed to generate initial images based on the input data provided by the user. This input data typically includes data 202/206 that define the desired appearance and context of the characters and settings. The AI model, which may be based on a large language model (LLM) integrated with a diffusion model, processes this input to create images that align with the specified parameters. The function of this AI model is to translate the data 202/206 into visual representations that serve as the initial drafts of the characters and scenes. These generated images provide the visuals that will be further refined through subsequent processes.

The model generation module 504 includes a fine-tuning module 604 designed to create customized generative models for each distinct character to be depicted in the interactive story. Specifically, this fine-tuning module receives a small set of images associated with an individual character-typically 3 to 10 images-which may include facial expressions, body postures, clothing styles, or other visual traits unique to that character. Using these inputs, the fine-tuning module performs a targeted training process-often using transfer learning architectures-to produce a “per-character model.” A per-character model is a specialized version of the underlying generative model (such as a diffusion model or text-to-image transformer) that encodes and preserves the unique visual attributes of a single character. This enables the generation of new images of that character in novel poses, angles, or scene contexts, while maintaining high visual consistency with the reference imagery.

The final subcomponent of the model generation module 504 is the second generative AI model 606, which builds on the work done by the fine-tuning module by utilizing the output from the per-character models to train the multi-character models. Once multiple per-character models are created, a second, higher-level generative model—referred to as a multi-character model—is trained using outputs from the per-character models. The purpose of the multi-character model is to learn how to integrate two or more per-character models into a shared scene or frame while preserving their individual identities and visual consistency. This hierarchical training structure enables the system to generate group scenes where multiple characters interact or co-appear in realistic or stylistically coherent ways. Training the multi-character model “based on” the per-character models means that the multi-character model receives image samples, conditioning vectors, or style embeddings from each per-character model as part of its input training data. It learns to harmonize lighting, composition, and spatial relationships while ensuring each character remains faithful to their personalized traits. This allows the resulting output to depict personalized characters interacting within the same environment-an essential component of generating complex scenes such as conversations, collaborative activities, or multi-character animations within the broader interactive story. This ensures that the characters look the same regardless of how they are depicted. The model's ability to maintain this consistency leads to overall coherence of the interactive story.

In step 308, the inpainting module 506 executes. The inpainting module is configured for enhancing character consistency within generated images, the inpainting module comprising: i) a character of interest identification sub-module 608 intended to locate or identify a character within an image, ii) an integration sub-module 610 configured to configured to position the in-painted characters similarly to the original control image, and iii) an appearance transfer module 612 that transfers a character's appearance to the control image providing a smooth blending that respects the likeness to the character of interest's appearance and the style of the control image. The inpainting module ensures that characters maintain consistent appearances across all generated images, even when modifications or adjustments are necessary.

The inpainting module 506 begins with the character of interest identification sub-module 608 intended to locate or identify a character within an image. This module 608 delineates the exact areas of the image that need to be modified or refined, such as background elements. The module ensures that any changes made during the inpainting process are confined to the intended regions. Following the creation of the inpainting masks, the integration sub-module 610 guides the generation of new scenes while positioning the in-painted characters similarly to the original control image. The module leverages the extracted character from the original or previous images as a control image. By using this control image as a reference, the module 610 guides the inpainting process to match the character's appearance in new scenes to the established visual standard. The module 610 maintains visual continuity across different scenes.

The final component of the inpainting module 506 is the appearance transfer module 612 that transfers a character's appearance to the control image providing a smooth blending that respects the likeness to the character of interest's appearance and the style of the control image. The module applies adjustments that are tailored to the unique visual characteristics of each character. This means that any modifications made during inpainting adhere to the overall consistency of the character's appearance and enhance it by adhering to the specified visual style. The integration ensures that the character remains visually coherent in new or altered scenes.

In step 310, the animation generation module 508 executes. The animation generation module comprises: i) a framework 614 configured to create customized visual animation sequences based on text prompts and generated images, and ii) an optional service integration module 616 configured to utilize third-party services for direct animation with limited control. The animation generation module 508 is configured to transform static images and narrative text into video sequences.

The animation generation module 508 includes a framework 614 configured to transform static visual and textual outputs into dynamic, coherent animation sequences. This framework operates by receiving text (such as text from the data input module or narrative text generated by the narrative generation module), along with the corresponding images created by the model generation and inpainting modules. Based on the semantic content of the text prompts
such as descriptions of motion, character actions, environmental transitions, or emotional shifts
the framework interprets and translates these textual cues into animated visual transitions. To achieve this, the framework may integrate motion modeling layers into a pre-trained diffusion architecture. The generated images serve as visual anchors for keyframes, and motion vectors or latent interpolations are applied across frames to produce fluid animation sequences that maintain stylistic fidelity and character consistency. In some embodiments, the image components within the animation framework are replaced with the previously fine-tuned per-character or multi-character models, ensuring that the animation accurately reflects the personalized character features and contextual cues derived from earlier stages in the pipeline. This tightly coupled design between narrative semantics, image generation, and animation synthesis allows the system to produce customized short-form video content where each frame is aligned with the story's events, tone, and character dynamics. The result is a visually engaging and narratively coherent animation.

The animation generation module 508 also includes an optional service integration module 616. This component is configured to enhance the system's flexibility by allowing the incorporation of third-party animation services to generate video sequences directly, with control over finer details of the animation. The service integration module allows users to produce animations quickly while using existing animation platforms with third-party capabilities.

In step 312, the narrative generation module 510 executes. The narrative generation module comprises: i) a dynamic prompting architecture configured to generate narrative text by leveraging professional screenwriting techniques and modular prompt structures, ensuring narrative cohesion and character trait preservation, and ii) a cultural sensitivity matrix and age-appropriate content filter configured to tailor the narrative content to specific developmental stages and cultural norms. The narrative generation module is configured for creating the textual content of the interactive story that is culturally sensitive and age-appropriate.

The narrative generation module includes a dynamic prompting architecture configured to generate narrative text by using screenwriting techniques, which are embedded within the system. This feature adapts to different storytelling needs, using modular prompt structures to create a variety of storylines while maintaining narrative cohesion. The prompt structures are carefully designed to ensure that the resulting text adheres to storytelling principles, such as character development, plot progression, and thematic consistency. The dynamic prompting architecture also preserves character traits throughout the narrative. The system uses the prompts to maintain the consistency of character behavior, dialogue, and development within the story.

The narrative generation module includes a cultural sensitivity matrix and age-appropriate content filter configured to tailor the narrative content to be appropriate for the target audience's age and cultural context. The cultural sensitivity matrix is an algorithmic tool that evaluates the generated narrative text to ensure that it aligns with the cultural norms and values of the intended audience. This prevents the inclusion of content that could be culturally insensitive or inappropriate. The age-appropriate content filter further refines the narrative by adjusting the complexity of the language, themes, and subject matter to match the audience. For example, if the story is intended for young children, the filter would ensure that the language is simple, the themes are light and educational, and the content is free from mature or potentially distressing material. On the other hand, for an older audience, the filter could allow for more complex language, deeper themes, and a broader range of topics.

In one embodiment, the output of the narrative generation module above may be used by the model generation module to create story specific images that adhere to the narrative that was generated. In this embodiment, step 312 of the control flow 300 is executed before step 306.

In step 314, the output module 512 executes. The output module is configured to combine the generated images, video sequences, and narrative text into a cohesive, interactive story and present the content that was generated (referred to as data 204; see FIG. 2) to a user. The output module merges the visual and textual components created by the other modules in the system. The generated images are aligned with the narrative text produced by the narrative generation module, ensuring that the characters, scenes, and actions correspond accurately with the storyline. For example, if the narrative describes a character entering a particular setting, the output module ensures that the corresponding images or video sequences are displayed in synchronization with the text.

In addition to combining static images and text, the output module also incorporates video sequences generated by the animation generation module. The video sequences are integrated with the narrative flow, serving as dynamic transitions between scenes or as visual representations of pieces of the story. The output module manages the timing and presentation of videos, ensuring that they comply with the narrative. Moreover, the output module assembles the various content elements into a user-friendly interface where the narrative text, images, and videos are displayed in a cohesive and organized manner. The module ensures that users can easily navigate through the story, with smooth transitions between different sections and interactive elements that allow for user input or choices that influence the direction of the story.

In additional embodiments, the disclosed system for automated interactive story generation can be further adapted to create personalized advertising images that embed specific individuals in generated content. This process leverages the core models of the control flow 300, with modifications and enhancements aimed at embedding a targeted person's image into an advertisement that prominently features a product. This alternative control flow provides a solution for producing highly customized advertising materials by integrating individualized user data and offering stylistic variations. The embedding process begins with a web scraping module that is designed to retrieve images of the targeted person. This module can be used to scan publicly available web content in order to collect images of the individual. The web scraping model operates by searching the internet for publicly accessible photographs or social media content of the targeted person, retrieving usable image data. This data is then fed into the subsequent modules of the system for further processing and customization.

Once the target's image is retrieved, an initial image generation model creates a template image. This template image can depict a generic scene in which a person is interacting with a product. For instance, the template might show a character opening the door of a specific car brand, holding a particular product, or engaging with a company's logo in some capacity. The initial generation model ensures that the overall advertisement scene is prepared before the individual's likeness is inserted.

The inpainting module of step 308 then proceeds to embed the target individual into the advertising image. By utilizing the inpainting technique, the inpainting module performs segmentation on the target individual's retrieved image and strategically inserts the person into the pre-generated advertising scene. The segmentation process identifies the contours and key features of the targeted person's image and aligns them with the context of the advertising scene. For example, if the advertisement depicts a person driving a car, the inpainting module will ensure that the targeted individual's image seamlessly blends into the position and posture of the driver in the car.

Subsequently, a style transfer model is employed to apply visual aesthetics to the generated image. The style transfer model allows for stylistic adjustments that can cater to the preferences of different advertisers or target audiences. By applying various styles, such as a muted color palette, a watercolor sketch look, or a vibrant, high-contrast finish, the style transfer model ensures that the final image aligns with the desired branding or marketing tone. The model allows advertisers to create visually diverse materials while retaining the same core scene with the embedded individual.

The web scraping module, initial image generation module, inpainting module, and style transfer model all enable the production of personalized and stylistic advertising images that feature targeted individuals engaging with branded products.

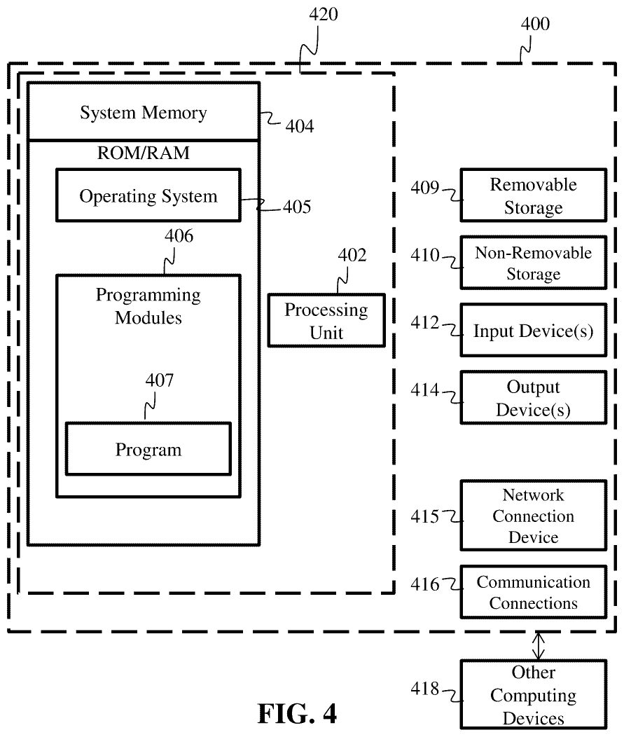

FIG. 4 is a block diagram of a system including an example computing device 400 and other computing devices. Consistent with the embodiments described herein, the aforementioned actions performed by 131, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of units 131, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods'stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented system for automatically generating personalized interactive stories, the system comprising:
a) a data input module configured for receiving reference images, text prompts, and scene details that define the appearance and context of characters and scenes;
b) a model generation module comprising: i) a first generative AI model configured to generate initial images based on the received reference images and text prompts; ii) a fine-tuning module configured to fine-tune the first generative AI model using a set of character-specific images to generate customized per-character models and multi-character models; and iii) a second generative AI model module configured to utilize output from the per-character models to train the multi-character models;
c) an inpainting module configured for transfer of a character's appearance to a control image, the inpainting module comprising: i) a character of interest identification sub-module configured to locate a character of interest within the control image; ii) an integration sub-module configured to position the character of interest similarly to the control image; and iii) an appearance transfer module configured to transfer the appearance of the character of interest to the control image by providing a smooth blending that respects the appearance of the character of interest and the style of the control image;
d) an animation generation module comprising: i) a framework configured to create customized visual animation sequences based on the text prompts and images that were generated; and ii) a service integration module configured to utilize third-party services for direct animation with limited control;
e) a narrative generation module comprising: i) a dynamic prompting architecture configured to generate narrative text by leveraging predefined screenwriting techniques and modular prompt structures, ensuring narrative cohesion and character trait preservation; and ii) a cultural sensitivity matrix and age-appropriate content filter configured to tailor the narrative content to specific developmental stages and cultural norms; and
f) an output module configured to combine the generated images, video sequences, and narrative text into a cohesive, interactive story and present the content that was generated to a user.

2. The computer-implemented system of claim 1, wherein the first generative AI model comprises a large language model (LLM) and diffusion model configured to generate images relevant to various scenes of the interactive story, and to match story details to a single image that is part of a collection of images relevant to the interactive story.

3. The computer-implemented system of claim 2, wherein the fine-tuning module further comprises a module configured to fine-tune the first generative AI model on a set of 5-10 character-specific images to enable high-quality image generation with minimal training data.

4. The computer-implemented system of claim 3, wherein the first generative AI model is configured to train multiple models specific to different aspects of a character, including face, clothing, and accessories, allowing for more granular control over the visual representation of the character.

5. The computer-implemented system of claim 4, wherein the inpainting module further comprises a control sub-module that enhances the consistency of the character's appearance across different scenes by using the extracted character image as a control image during the generation process.

6. The computer-implemented system of claim 5, wherein the character of interest identification sub-module comprises a model for creating highly precise inpainting masks that ensure accurate modification of specific areas within the generated images.

7. The computer-implemented system of claim 6, wherein the animation generation module further comprises a framework configured to generate motion sequences that align with the narrative text, by integrating the customized character models into the video sequences generated from text prompts.

8. The computer-implemented system of claim 7, wherein the narrative generation module further includes a proprietary algorithm configured to balance narrative structure, character consistency, and adaptive storytelling elements to create unique and culturally relevant stories within a cohesive narrative universe.

9. The computer-implemented system of claim 8, wherein the dynamic prompting architecture of the narrative generation module is configured to automatically generate and adjust prompts based on predefined character traits, story arcs, and user preferences, ensuring the preservation of character integrity while allowing for creative storytelling.

10. The computer-implemented system of claim 9, wherein the output module is further configured to allow user interaction by enabling the selection of specific scenes, characters, and story elements, thus providing a customizable interactive storytelling experience.

11. A computer-implemented system for automatically generating personalized interactive stories, the system comprising:
a) a data input module configured for receiving reference images, text prompts, and scene details that define the appearance and context of characters and scenes;
b) a model generation module comprising: i) a first generative AI model configured to generate initial images based on the received reference images and text prompts; ii) a fine-tuning module configured to fine-tune the first generative AI model using a set of character-specific images to generate customized per-character models and/or multi-character models; and iii) a second generative AI model module configured to utilize output from the per-character models to train the multi-character models;
c) an inpainting module configured for transfer of a character's appearance to a control image, the inpainting module comprising: i) a character of interest identification sub-module configured to locate a character of interest within the control image; ii) an integration sub-module configured to position the character of interest similarly to the control image; and iii) an appearance transfer module configured to transfer the appearance of the character of interest to the control image by providing a smooth blending that respects the appearance of the character of interest and the style of the control image;
d) an animation generation module comprising a framework configured to create customized visual animation sequences based on the text prompts and images that were generated;
e) a narrative generation module comprising: i) a dynamic prompting architecture configured to generate narrative text by leveraging predefined screenwriting techniques and modular prompt structures, ensuring narrative cohesion and character trait preservation; and ii) a cultural sensitivity matrix and age-appropriate content filter configured to tailor the narrative content to specific developmental stages and cultural norms; and
f) an output module configured to combine the generated images, video sequences, and narrative text into a cohesive, interactive story and present the content that was generated to a user.

12. The computer-implemented system of claim 11, wherein the first generative AI model comprises a large language model (LLM) and diffusion model configured to generate images relevant to various scenes of the interactive story, and to match story details to a single image that is part of a collection of images relevant to the interactive story.

13. The computer-implemented system of claim 12, wherein the fine-tuning module further comprises a module configured to fine-tune the first generative AI model on a set of 5-10 character-specific images to enable high-quality image generation with minimal training data.

14. The computer-implemented system of claim 13, wherein the first generative AI model is configured to train multiple models specific to different aspects of a character, including face, clothing, and accessories, allowing for more granular control over the visual representation of the character.

15. The computer-implemented system of claim 14, wherein the inpainting module further comprises a control sub-module that enhances the consistency of the character's appearance across different scenes by using the extracted character image as a control image during the generation process.

16. The computer-implemented system of claim 15, wherein the character of interest identification sub-module comprises a model for creating highly precise inpainting masks that ensure accurate modification of specific areas within the generated images.

17. The computer-implemented system of claim 16, wherein the animation generation module further comprises a framework configured to generate motion sequences that align with the narrative text, by integrating the customized character models into the video sequences generated from text prompts.

18. The computer-implemented system of claim 17, wherein the narrative generation module further includes a proprietary algorithm configured to balance narrative structure, character consistency, and adaptive storytelling elements to create unique and culturally relevant stories within a cohesive narrative universe.

19. The computer-implemented system of claim 18, wherein the dynamic prompting architecture of the narrative generation module is configured to automatically generate and adjust prompts based on predefined character traits, story arcs, and user preferences, ensuring the preservation of character integrity while allowing for creative storytelling.

20. The computer-implemented system of claim 19, wherein the output module is further configured to allow user interaction by enabling the selection of specific scenes, characters, and story elements, thus providing a customizable interactive storytelling experience.
